(19) United States
(12) Patent Application Publication
(10) Pub. No.: US 2022/0314225 A1
(43) Pub. Date: Oct. 6, 2022

(54) CONTAINER FOR A REACTIVE PRODUCT EQUIPPED WITH A SUCTION TUBE

(71) Applicant: ARTEION, Paris (FR)

(72) Inventor: Alain ROUSSEAU, Paris (FR)

(21) Appl. No.: 17/639,307

(22) PCT Filed: Jul. 8, 2020
(86) PCT No.: PCT/FR2020/051214

§ 371 Date: Feb. 28, 2022

(30) Foreign Application Priority Data
Sep. 20, 2019 (FR) 19/10391

(51) Int. Cl. B01L 3/00; B01L 3/02; G01N 35/10

(52) U.S. Cl. CPC B01L 3/523; B01L 3/0293; G01N 35/1002; G01N 35/1079; B01L 2200/0689; B01L 2200/16; B01L 2300/042; B01L 2300/044; B01L 2300/0672

(57) ABSTRACT

A container for a reactive product including a container body having a neck delimiting a neck opening; a closure member comprising a puncturable closure membrane which tightly seals off the neck opening; a suction tube located in the container body and comprising a first end portion attached to the closure member and a second end portion extending in the proximity of the bottom of the container body; and a cap attached to the neck and comprising a passage opening which is located facing the puncturable closure membrane and the first end portion of the suction tube, the cap being configured so as to enable the penetration of a sampling needle through the passage opening and the puncturable closure membrane such that the sampling needle is fluidly connected to the suction tube, and so as to enable the penetration of a venting needle through the passage opening and the puncturable closure membrane such that the venting needle is fluidly connected to an internal volume of the container body.

### CROSS REFERENCE TO RELATED APPLICATIONS

This application is a National Stage of PCT Application No. PCT/FR2020/051214 filed on Jul. 8, 2020, which claims priority to French Patent Application No. 19/10391 filed on Sep. 20, 2019, the contents each of which are incorporated herein by reference thereto.

### TECHNICAL FIELD

The present invention concerns a container for a reactive product, and a sampling device intended to be equipped with such a container.

### BACKGROUND

An analysis apparatus, such as an in vitro analysis apparatus, includes in a known manner:
a storage device configured to store a plurality of containers for a reactive products, each container including a container body comprising a neck delimiting a neck opening, and a puncturable closure membrane which tightly seals off the neck opening, and
a sampling device including in particular a sampling needle which is configured to puncture the puncturable closure membrane of a container received in the storage device and to sample part of the content of this container in order to supply with a reagent for example an analysis cuvette containing a biological liquid sample to be analyzed.

In particular, such a configuration of each container for a reactive product does not enable the sampling device to sample the entirety of the content of this container, which necessarily induces losses of reactive products and therefore a significant consumption of reactive products by an analysis laboratory. Such consumption of reactive products has a significant impact on the costs of the tests to be carried out by an analysis laboratory.

To overcome such a drawback, it could be considered to provide a sampling needle having a length substantially corresponding to the height of the container. Nonetheless, such a configuration of the sampling needle complicates the sampling device, and substantially increases the manufacturing costs of the analysis apparatus.

In order to be able to sample substantially the entirety of the content of a container, it is also known to replace the sampling needle with a flexible sampling tube intended to be inserted into a container after removal of a cap equipping the container and loading of the latter in the analysis apparatus. Yet, the initial removal of the cap off a container before loading thereof into the storage device and positioning of the sampling tube in the container complicate the manual operations to be accomplished by a user of such an analysis apparatus, while increasing the risks of contamination of the reactive product contained in the container.

### BRIEF SUMMARY

The present invention aims at overcoming all or part of these drawbacks.

The technical problem at the basis of the invention therefore consists in providing a container for a reactive product which has a simple and ergonomic structure, while allowing significantly reducing the costs of the tests to be carried out by an analysis laboratory and limiting the risks of contamination of the content of the container.

To this end, the present invention concerns a container for a reactive product, and in particular fora liquid reactive product, comprising:
a container body comprising a neck delimiting a neck opening,
a closure member comprising a puncturable closure membrane which tightly seals off the neck opening,
a suction tube located in the container body and comprising a first end portion attached to the closure member and a second end portion extending in the proximity of the bottom of the container body, and
a cap attached to the neck of the container body, the cap comprising a passage opening which is located facing the puncturable closure membrane and the first end portion of the suction tube, the cap being configured so as to enable the penetration of a sampling needle through the passage opening and the puncturable closure membrane such that the sampling needle is fluidly connected to the suction tube, and so as to enable the penetration of a venting needle through the passage opening and the puncturable closure membrane such that the venting needle is fluidly connected to an internal volume of the container body.

Such a configuration of the container, and in particular the fact that the second end portion of the suction tube is located in the proximity of the bottom of the container body, allows sampling all or substantially all of the content of the container with a sampling device equipped with a regular-size sampling needle. These arrangements allow limiting the losses of reactive products, and therefore reducing the consumption of reactive products for an analysis laboratory and therefore reducing the costs of the tests to be carried out by the analysis laboratory.

Furthermore, the particular configuration of the closure member, and in particular the fact that the suction tube is directly attached to the closure member, allows reducing the manufacturing costs of the container, and therefore further reducing the costs of the tests to be carried out by the analysis laboratory.

In addition, the presence of the puncturable closure membrane confers great tightness on the container before the first use of the latter and between two uses of the latter, which limits the risks of contamination of the content of the container.

The specific configuration of the container according to the present invention also enables loading of the container into an analysis apparatus without any prior operation by a user, such as the removal of a cap or the insertion of a flexible sampling tube equipping the sampling device in the container, which greatly facilitates this loading and further limits the risks of contamination of the content of the container.

Hence, the container according to the present invention allows simplifying and securing the loading of the container into an analysis apparatus.

The container may further have one or more of the following features, considered alone or in combination.

According to an embodiment of the invention, the puncturable closure membrane includes a first membrane portion which is located facing the first end portion of the suction tube, and a second membrane portion which is substantially coplanar with the first membrane portion and which is offset with respect to the first membrane portion, the passage opening being located facing the first membrane portion and the second membrane portion, the cap being configured so as to enable the penetration of a sampling needle through the passage opening and the first membrane portion such that the sampling needle is fluidly connected to the suction tube, and for example emerges opposite or into the first end portion of the suction tube, and so as to enable the penetration of a venting needle through the passage opening and the second membrane portion such that the venting needle is fluidly connected to the internal volume of the container body, and for example emerges into the internal volume of the container body.

According to an embodiment of the invention, the second membrane portion is annular and extends around the first membrane portion. Advantageously, the first and second membrane portions are concentric.

According to an embodiment of the invention, the cap is configured so as to enable the penetration of a sampling needle through the passage opening and the puncturable closure membrane such that the sampling needle emerges opposite or into the first end portion of the suction tube, and so as to enable the penetration of a venting needle through the passage opening and the puncturable closure membrane such that the venting needle emerges into the internal volume of the container body, and for example into an annular volume partially delimited by the container body, and advantageously partially by the neck of the container body. Advantageously, the annular volume may extend substantially coaxially with the suction tube. The annular volume may for example extend at least partly around the first end portion of the suction tube.

According to an embodiment of the invention, the cap is configured so as to enable the penetration of a sampling needle through the passage opening and the puncturable closure membrane such that the sampling needle extends at least partially into the suction tube.

According to an embodiment of the invention, the passage opening is located facing a central portion of the puncturable closure membrane.

According to an embodiment of the invention, the closure member comprises a tubular mounting portion which is located in the container body and which extends from the puncturable closure membrane, the first end portion of the suction tube being attached to the tubular mounting portion and being fluidly connected to an internal channel defined by the tubular mounting portion.

According to an embodiment of the invention, the cap is configured so as to enable the penetration of a sampling needle through the passage opening and the puncturable sampling membrane and into the internal channel of the tubular mounting portion, and so as to enable the penetration of a venting needle through the passage opening and the puncturable sampling membrane and into the annular volume, which may for example be delimited by the neck of the body container and the tubular mounting portion.

According to an embodiment of the invention, the cap is made of a rigid plastic material.

According to an embodiment of the invention, the puncturable closure membrane comprises a first face oriented towards the interior of the container body and a second face opposite to the first face, the tubular mounting portion extending from the first face of the puncturable sampling membrane.

According to an embodiment of the invention, the tubular mounting portion extends from the central portion of the puncturable sampling membrane. Advantageously, the central portion of the puncturable closure membrane includes the first membrane portion and the second membrane portion. The tubular mounting portion may for example extend from the first membrane portion.

According to an embodiment of the invention, the central portion of the puncturable closure membrane tightlu seals off the end of the tubular mounting portion which is oriented towards the puncturable closure membrane.

According to an embodiment of the invention, the first end portion of the suction tube extends substantially parallel to a central axis of the neck of the container body.

According to an embodiment of the invention, the tubular mounting portion extends according to an axis of extension which is substantially parallel to the central axis of the neck of the container body, and which may for example be substantially perpendicular to the puncturable closure membrane.

According to an embodiment of the invention, the axis of extension of the tubular mounting portion is substantially coincident with the central axis of the neck.

According to an embodiment of the invention, the puncturable closure membrane seals off, preferably tightly, the passage opening.

According to an embodiment of the invention, the puncturable closure membrane covers, and preferably in a fluid-tight manner, the passage opening.

According to an embodiment of the invention, the puncturable closure membrane has a disk-like general shape.

According to an embodiment of the invention, the puncturable closure membrane is generally planar.

According to an embodiment of the invention, the closure member is made in one-piece, that is to say is made in one single part.

According to an embodiment of the invention, the closure member is made of an elastomer.

According to an embodiment of the invention, the cap partially covers the puncturable closure membrane.

According to an embodiment of the invention, the closure member includes an annular sealing rib extending over the second face of the puncturable closure membrane. The presence of such an annular sealing rib allows ensuring optimum sealing between the closure member and the sampling needle, even when sealing between the puncturable closure membrane and the sampling needle is faulty in particular due to the fact that the container has been unloaded before from the analysis apparatus and then reloaded into the analysis apparatus.

According to an embodiment of the invention, the annular sealing rib and the tubular mounting portion extend substantially coaxially.

According to an embodiment of the invention, the passage opening and the tubular mounting portion extend substantially coaxially.

According to an embodiment of the invention, the central portion of the puncturable closure membrane is located upstream of the passage opening with respect to the direction of insertion of the sampling needle through the puncturable closure membrane.

According to an embodiment of the invention, the central portion of the puncturable sampling membrane is located downstream of the passage opening with respect to the direction of insertion of the sampling needle through the puncturable closure membrane.

According to an embodiment of the invention, the cap is configured to exert a pressure on the puncturable closure membrane, and in particular to compress the puncturable closure membrane, so as to achieve a tight, and preferably fluid-tight, mounting of the puncturable closure membrane on the neck of the container body.

According to an embodiment of the invention, the cap includes a bottom wall and a lateral skirt extending from the bottom wall, the passage opening being provided on the bottom wall.

According to an embodiment of the invention, the lateral skirt comprises a first fastening element configured to cooperate, for example by screwing, tightening or snap-fastening, with a second fastening element provided on the neck of the container body.

According to an embodiment of the invention, the first fastening element is an annular fastening rib provided on an inner surface of the lateral skirt, and the second fastening element is an annular fastening groove which is provided on an outer surface of the neck of the container body and which is configured to cooperate by snap-fastening with the annular fastening rib.

According to an embodiment of the invention, the first fastener includes an internal thread provided on an inner surface of the lateral skirt, and the second fastening element includes an external thread which is provided on an outer surface of the neck of the body container and which is configured to cooperate by screwing with the internal thread provided on the lateral skirt.

According to an embodiment of the invention, the cap is removably attached to the neck of the container body.

According to an embodiment of the invention, the cap is distinct from the closure member.

According to an embodiment of the invention, the cap and the closure member are made by overmoulding. Nonetheless, the cap and the closure member could also be made by bi-injection molding.

According to an embodiment of the invention, the puncturable closure membrane includes a peripheral mounting portion which is tightly mounted on the neck of the container body.

According to an embodiment of the invention, the first end portion of the suction tube is attached in the internal channel delimited by the tubular mounting portion.

According to an embodiment of the invention, the passage section of the passage opening is larger than the cross-section of the tubular mounting portion.

According to an embodiment of the invention, the tubular mounting portion is overmolded onto the suction tube.

According to an embodiment of the invention, the suction tube and the closure member are made integrally in one-piece.

According to an embodiment of the invention, a suction opening defined by the second end portion of the suction tube includes at least one first opening portion and one second opening portion which are axially offset with respect to one another. These arrangements allow avoiding the second end portion of the suction tube coming into tight or almost tight contact with the bottom of the container body, which could alter the suction of the content of the container when the latter is loaded into a sampling device. The suction opening of the second end portion may for example extend in an opening plane which is inclined with respect to the longitudinal axis of the second end portion, or have a curved and in particular concave edge portion.

The present invention further concerns a sampling device including:
a frame,
a receiving portion including a receiving location configured to receive a container according to the present invention, and
a sampling head configured to sample at least part of the content of the container when the container is received in the receiving location, the sampling head being movably mounted relative to the frame between an inactive position and a sampling position, the sampling head including a sampling needle which is configured to puncture the puncturable closure membrane of the container and to be fluidly connected to the suction tube of the container when the container is received in the receiving location and when the sampling head is moved into the sampling position, and a venting needle which is configured to puncture the puncturable closure membrane of the container and to be fluidly connected to the internal volume of the container when the container is received in the receiving location and when the sampling head is moved into the sampling position.

According to an embodiment of the invention, the sampling needle is configured to puncture the puncturable closure membrane of the container and to emerge opposite or into the first end portion of the suction tube when the container is received in the receiving location and when the sampling head is displace into the sampling position, and the venting needle is configured to puncture the puncturable closure membrane of the container and to emerge into the internal volume of the container body, and for example into the annular volume partially delimited by the container body, when the container is received in the receiving location and when the sampling head is displaced into the sampling position.

According to an embodiment of the invention, the sampling needle is configured to puncture the puncturable closure membrane of the container and to extend at least partially into the suction tube when the container is received in the receiving location and when the sampling head is displaced into the sampling position.

According to an embodiment of the invention, the sampling needle is configured to puncture the puncturable closure membrane of the container and to extend into the internal channel of the tubular mounting portion of the container when the container is received in the receiving location and when the sampling head is displaced into the sampling position, and the venting needle is configured to puncture the puncturable closure membrane of the container and to emerge into the annular volume, which may for example be delimited by the tubular mounting portion and the neck of the container, when the container is received in the receiving location and when the sampling head is displaced into the sampling position.

According to an embodiment of the invention, the receiving location is open upwards.

According to an embodiment of the invention, the sampling needle is configured to extend partially into the first end portion of the suction tube when the container is received in the receiving location and when the sampling head is in the sampling position.

According to an embodiment of the invention, the sampling head is pivotably mounted relative to the frame about a pivot axis.

According to an embodiment of the invention, the receiving portion is movably mounted relative the frame between a first position in which a container can be inserted into the receiving location of said receiving portion, and a second position in which the sampling needle and the venting needle are capable of extending through the puncturable closure membrane of said container.

According to an embodiment of the invention, the receiving portion is configured to be substantially inclined with respect to the vertical when the receiving portion is in the first position, and the receiving portion is configured to extend substantially vertically when the receiving portion is in the second position.

According to an embodiment of the invention, the receiving portion is slidably mounted relative to the frame according to a sliding direction. Advantageously, the sliding direction is substantially rectilinear. According to an embodiment of the invention, the sliding direction extends transversely, and for example substantially perpendicularly, to the pivot axis of the sampling head.

According to an embodiment of the invention, the receiving portion includes a guide element slidably mounted in a guide slot provided on the frame and extending according to the sliding direction.

According to an embodiment of the invention, the sampling head is mechanically connected to the receiving portion such that a displacement of the receiving portion from the first position towards the second position automatically causes a displacement of the sampling head from the inactive position towards the sampling position, and such that a displacement of the receiving portion from the second position towards the first position automatically causes a displacement of the sampling head from the sampling position towards the inactive position.

According to an embodiment of the invention, the receiving portion is slidably mounted on the sampling head according to a direction of displacement. For example, the direction of displacement may extend substantially parallel to the direction of extension of the sampling needle.

According to an embodiment of the invention, the direction of displacement extends transversely, and for example substantially perpendicularly, to the pivot axis of the sampling head.

According to an embodiment of the invention, the sampling head includes a positioning portion configured to cooperate with the cap of a container received in the receiving location, so as to position the cap of the container in a predetermined position with respect to the sampling needle.

According to an embodiment of the invention, the positioning portion is configured to cover, and for example to cap, the cap of a container received in the receiving location.

According to an embodiment of the invention, the positioning portion is configured to align the sampling needle with the tubular mounting portion of a container when the sampling head occupies the sampling position and when the container is received in the receiving location.

According to an embodiment of the invention, the positioning portion is a positioning tulip, also called positioning cap.

According to an embodiment of the invention, the positioning portion includes a receiving housing which is open downwards and which is configured to at least partially house the cap of a container received in the receiving location.

According to an embodiment of the invention, the positioning portion includes a bottom and a side wall which delimit the receiving housing, the sampling needle and the venting needle extending through the bottom of the positioning portion and protruding into the receiving housing.

According to an embodiment of the invention, the side wall of the positioning portion is configured to cooperate with the cap, and more particularly with the lateral skirt of the cap.

Advantageously, the positioning portion includes an insertion opening through which the cap could be inserted into the receiving housing, the insertion opening being internally delimited at least in part by a frustoconical surface which converges towards the bottom of the positioning portion.

According to an embodiment of the invention, the sampling head includes a biasing device configured to bias the cap of the container outside the receiving housing, when the sampling head is displaced towards the inactive position. Advantageously, the biasing device is disposed in the receiving housing.

According to an embodiment of the invention, the biasing device includes a bearing member which is configured to bear against the cap of the container and which is movably mounted in the receiving housing between a protection position in which the sampling and venting needles are located set back from the bearing member and a retracted position in which the sampling and venting needles protrude from the bearing member, and a biasing element, such as a coil spring, configured to bias the bearing member towards the protection position. Advantageously, the cap of the container is configured to displace the bearing member from the protection position towards the retracted position when the receiving portion is displaced from the first position towards the second position.

According to an embodiment of the invention, the bearing member is located in the proximity of the insertion opening when the bearing member occupies the protection position, and is located at a distance from the insertion opening when the bearing member occupies the retracted position.

According to an embodiment of the invention, the positioning portion includes an abutment surface against which the bearing member abuts when the bearing member is in the protection position. Thus, the abutment surface is configured to limit the displacement travel of the bearing member towards the insertion opening.

According to an embodiment of the invention, the sampling head, and for example the positioning portion, is configured to exert a pressure on the annular sealing rib of the closure member, and in particular to compress the annular sealing rib, when the sampling head occupies the sampling position and the container is received in the receiving location.

According to an embodiment of the invention, the sampling device includes an air filter which is located upstream of the venting needle and which is configured to filter the air intended to flow through the venting needle.

According to an embodiment of the invention, the sampling head includes a gripping portion, such as a gripping handle, so as to enable a manual displacement of the sampling head between the inactive position and the sampling position.

According to an embodiment of the invention, the sampling device includes a biasing element configured to bias the sampling head towards the inactive position.

According to an embodiment of the invention, the sampling device includes at least one container according to the present invention.

According to an embodiment of the invention, the sampling device includes a plurality of receiving portions each including a receiving location configured to receive a respective container for a reactive product.

According to an embodiment of the invention, the sampling device includes a plurality of sampling heads each configured to sample at least part of the content of a container received in a receiving location of a respective receiving portion.

### BRIEF DESCRIPTION OF THE DRAWINGS

Anyway, the invention will be better understood from the following description with reference to the appended diagrammatic drawings representing, as non-limiting examples, several embodiments of this container.

FIG. 1 is a longitudinal sectional view of a container for a reactive product according to a first embodiment of the invention.

FIG. 2 is a truncated partial perspective view of the container of FIG. 1.

FIG. 3 is a top view of the container of FIG. 1.

FIG. 4 is a perspective view of a sampling device according to a first embodiment of the invention.

FIG. 5 is a longitudinal sectional view of the sampling device of FIG. 4 showing a sampling head in an inactive position.

FIG. 6 is a longitudinal sectional view of the sampling device of FIG. 4 showing a sampling head in an intermediate position.

FIG. 7 is a longitudinal sectional view of the sampling device of FIG. 4 showing a sampling head in a sampling position.

FIG. 8 is a partial longitudinal sectional view of the sampling device of FIG. 4 showing a sampling head in the sampling position.

FIG. 9 is a longitudinal sectional view of container for a reactive product according to a second embodiment of the invention.

FIG. 10 is a partial perspective top view of the container of FIG. 9.

FIG. 11 is a truncated partial perspective view of the container of FIG. 9.

FIG. 12 is a perspective view of a sampling device according to a second embodiment of the invention.

FIG. 13 is a partial longitudinal sectional view of the sampling device of FIG. 12 showing a sampling head respectively in the inactive position and the sampling position.

FIG. 14 is a truncated perspective view of the sampling device of FIG. 12 showing a sampling head in the sampling position.

FIG. 15 is a partial longitudinal sectional view, on an enlarged scale, of the sampling device of FIG. 12 showing a sampling head in the sampling position.

### DETAILED DESCRIPTION

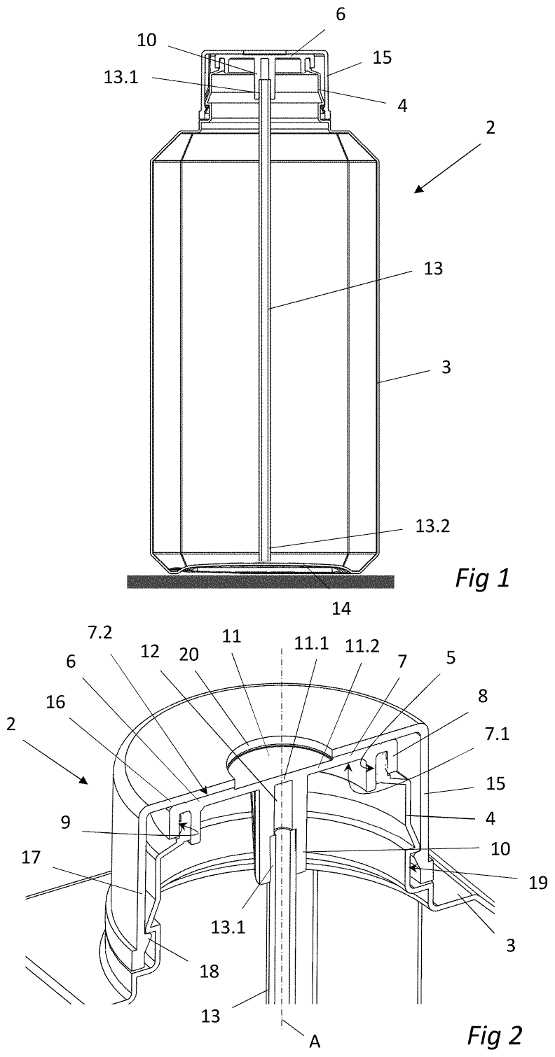

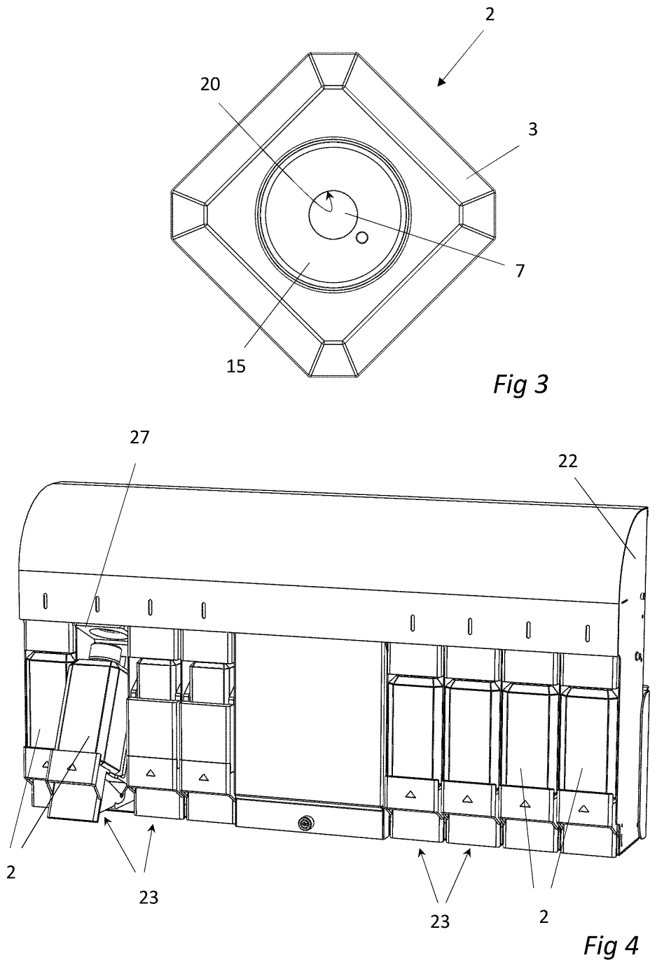

FIGS. 1 to 3 represent a container 2 for a reactive product, and in particular for a liquid reactive product, according to a first embodiment of the invention. The container 2 represented in FIGS. 1 to 3 is a vial for a reactive product and has a capacity of less than 300 ml, and may for example have a capacity of 50 ml or 250 ml. In particular, such a container 2 may be used to contain a reactive product the required amount of which per test is about 250 μl or less.

The container 2 comprises a container body 3 comprising a neck 4 delimiting a neck opening 5. For example, the container body 3 may be made of a plastic material. The container 2 also includes a closure member 6 which is advantageously made in one-piece, and which may for example be made of an elastomer.

The closure member 6 comprises a puncturable closure membrane 7 which tightly seals off the neck opening 5. The puncturable closure membrane 7 has a disk-like general shape, and is generally planar. The puncturable closure membrane 7 comprises a first face 7.1 oriented towards the inside of the container body 3 and a second face 7.2 opposite to the first face 7.1. According to the first embodiment of the invention, the puncturable closure membrane 7 includes a peripheral mounting portion 8 which is tightly mounted on the neck 4 of the container body 3. For example, the peripheral mounting portion 8 may include an annular mounting groove 9 in which is attached the bottleneck of the neck 4.

The closure member 6 further comprises a tubular mounting portion 10 which is located in the container body 3 and which extends from the first face 7.1 of the puncturable closure membrane 7. The tubular mounting portion 10 extends more particularly from a central portion 11 of the puncturable closure membrane 7 and according to an axis of extension A which is substantially parallel to a central axis of the neck 4 of the container body 3. Advantageously, the axis of extension A of the tubular mounting portion 10 is coincident with the central axis of the neck 4.

The tubular mounting portion 10 delimits an internal channel 12 whose end facing the puncturable closure membrane 7 is tightly sealed by the central portion 11 of the puncturable closure membrane 7.

The container 2 further includes a suction tube 13 comprising a first end portion 13.1 attached to the tubular mounting portion 10, and more particularly attached in the internal channel 12 delimited by the tubular mounting portion 10, and a second end portion 13.2 extending in the proximity of the bottom 14 of the container body 3. Thus, the suction tube 13 is fluidly connected to the internal channel 12 delimited by the tubular mounting portion 10.

The container 2 further includes a cap 15 which is attached to the neck 4 of the container body 3, and which may for example be made of a rigid plastic material. According to the first embodiment of the invention, the cap 15 is distinct from the closure member 6 and partially covers the puncturable closure membrane 7. Advantageously, the cap 15 is configured to exert a pressure on the puncturable closure membrane 7, and in particular to compress the puncturable closure membrane 7, so as to achieve a fluid-tight mounting of the puncturable closure membrane 7 on the neck 4 of the container body 3.

As shown more particularly in FIG. 2, cap 15 has a bottom wall 16 and a lateral skirt 17 extending from the bottom wall 16. The inner surface of the lateral skirt 17 comprises a first fastening element 18, such as an annular fastening rib, configured to by snap-fastening with a second fastening element 19, such as an annular fastening groove, provided on an outer surface of the neck 4 of the container body 3. Advantageously, the bottom wall 16 of the cap 15 bears against the second face 7.2 of the puncturable closure membrane 7.

The cap 15 includes in particular a passage opening 20 which is provided on the bottom wall 16 and which is located facing the central portion 11 of the puncturable closure membrane 7. Advantageously, the central portion 11 of the puncturable closure membrane 7 includes a first membrane portion 11.1 from which extends the tubular mounting portion 10, and a second membrane portion 11.2 which extends around the first membrane portion 11.1. The first and second membrane portions 11.1, 11.2 may for example be concentric.

The passage opening 20 is more particularly configured so as to enable the penetration of a sampling needle through the first membrane portion 11.1 and into the internal channel 12 of the tubular mounting portion 10, and so as to enable the penetration of a venting needle through the second membrane portion 11.2 and into an annular volume delimited by the neck 4 of the container body 3 and the tubular mounting portion 10. Advantageously, the passage opening 20 is circular, and is sealed, preferably tightly, by the central portion 11 of the puncturable closure membrane 7.

According to the first embodiment of the invention, the passage opening 20 and the tubular mounting portion 10 extend coaxially, and the central portion of the puncturable closure membrane 7 is located downstream of the passage opening 20 with respect to the direction of insertion of a sampling needle through the puncturable closure membrane 7.

FIGS. 4 to 8 represent a sampling device 21 according to a first embodiment of the invention which is configured to receive a plurality of containers 2 according to the embodiment represented in FIGS. 1 to 3. For example, the sampling device 21 can equip an analysis device for in vitro diagnosis.

The sampling device 21 includes a frame 22, and a plurality of receiving portions 23 each including a receiving location 24 configured to receive a respective container 2. Each receiving location 24 is advantageously open upwards. According to the embodiment represented in FIGS. 4 to 8, the sampling device 21 includes a first set of receiving portions including several receiving portions 23, for example four, which are disposed adjacent to each other, and a second set of receiving portions including several receiving portions 23, for example four, which are disposed adjacent to each other.

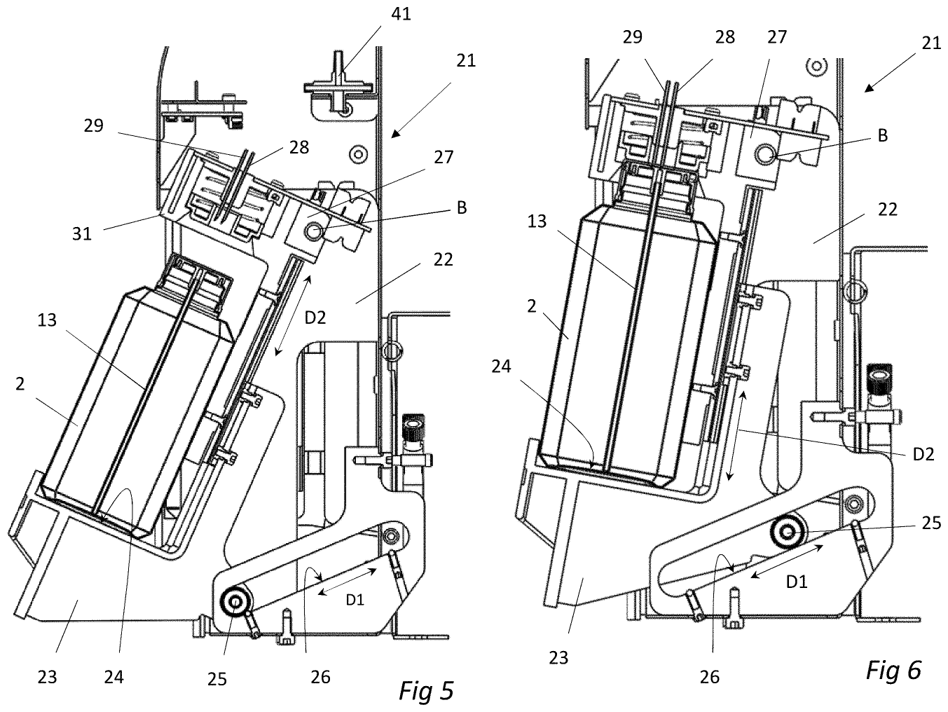

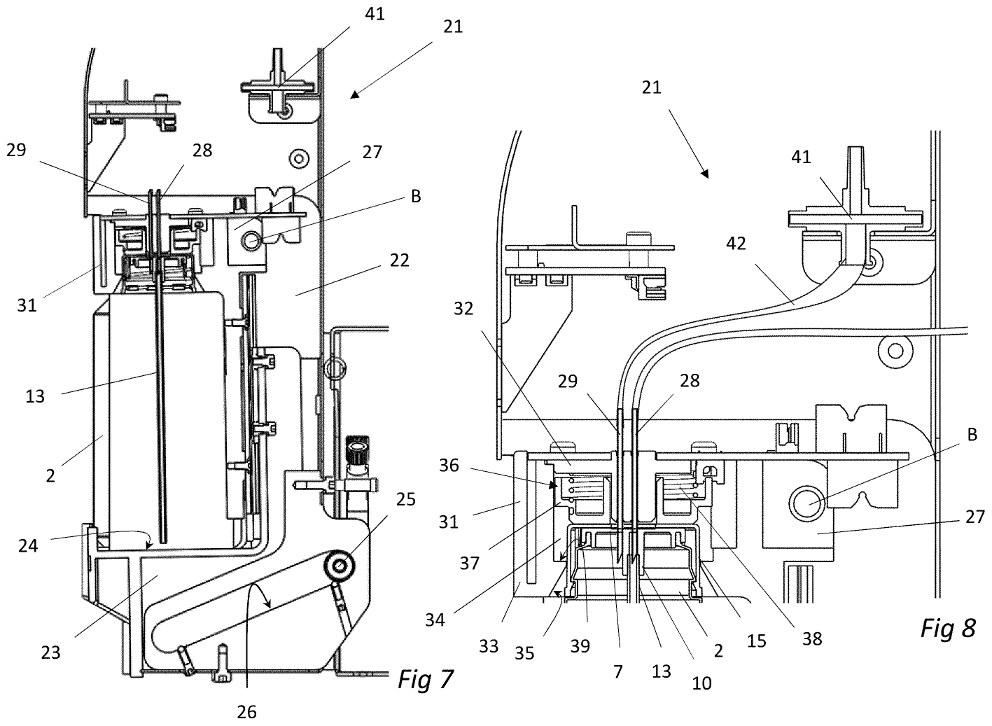

Each receiving portion 23 is slidably mounted relative to the frame 22 according to a sliding direction D1 and between a first position (cf. FIG. 5), also called the loading/unloading position, in which the receiving portion 23 is inclined with respect to the vertical and a respective container 2 can be inserted into the respective receiving location 24, and a second position (see FIG. 7), also called storage position, in which the receiving portion 23 extends vertically and holds the respective container 2 in position. Advantageously, the sliding direction D1 of each receiving portion 23 is substantially rectilinear. Each receiving portion 23 may for example include a guide element 25, such as a guide rod, slidably mounted in a respective guide slot 26 provided on the frame 22 and extending according to the sliding direction D1.

The sampling device 21 further includes a plurality of sampling heads 27 each associated with a respective receiving portion 23, and each configured to sample at least part of the content of a respective container 2 received in the respective receiving location 24. Advantageously, each sampling head 27 is disposed above the respective receiving portion 23.

Each sampling head 27 includes a sampling needle 28 and a venting needle 29. Each sampling head 27 is more particularly pivotably mounted relative to the frame 22 about a pivot axis B and between an inactive position (cf. FIG. 5) in which the respective receiving portion 23 is in the first position and the sampling head 27 is located at a distance from the cap 15 of the container 2 received in the respective receiving location 24, and a sampling position (cf. FIG. 7) in which the respective receiving portion 23 is in the second position and the sampling needle 28 and the venting needle 29 of said sampling head 27 are configured to extend through the puncturable closure membrane 7 of the container 2 received in the respective receiving location 24. Advantageously, the sliding direction D1 of each receiving portion 23 extends transversely, and for example substantially perpendicularly, to the pivot axis B of the respective sampling head 27.

The sampling needle 28 of each sampling head 27 is more particularly configured to puncture the puncturable closure membrane 7 of the respective container 2 and to extend into the internal channel 12 of the tubular mounting portion 10 of the respective container 2 when said sampling head 27 is in the sampling position, and the venting needle 28 of each sampling head 27 is more particularly configured to puncture the puncturable closure membrane 7 of the respective container 2 and to emerge into the container body 3 of the respective container 2 when said sampling head 27 is in the sampling position. Advantageously, the sampling needle 27 of each sampling head 27 is also configured to extend partially into the first end portion 13.1 of the suction tube 13 of the respective container 2 when the respective sampling head 27 is in the sampling position, and the venting needle 28 of each sampling head 27 is configured to extend partially into the annular volume delimited by the neck 4 of the respective container 2 and the tubular mounting portion 10 respective when the respective sampling head 27 is in the sampling position.

According to the embodiment represented in FIGS. 4 to 8, each sampling head 27 is mechanically connected to the respective receiving portion 23 such that a displacement of the respective receiving portion 23 from the first position towards the second position automatically and mechanically causes a displacement of said sampling head 27 from the inactive position towards the sampling position, and such that a displacement of the respective receiving portion 23 from the second position towards the first position automatically and mechanically causes a displacement of said sampling head 27 from the sampling position towards the inactive position. Such a configuration of the sampling device 21 allows greatly simplifying the manual operations to be carried out by a user of the sampling device 21, while simplifying the operation of the sampling device 21. These arrangements ensure great ergonomics for the user and great reliability for the sampling device 21.

Advantageously, each receiving portion 23 is slidably mounted on the respective sampling head 27 in a direction of displacement D2 which extends transversely, and preferably substantially perpendicularly, to the pivot axis B of the respective sampling head 27.

Thus, after positioning a container 2 in the receiving location 24 of a receiving portion 23, a simple displacement of said receiving portion 23 from the first position towards the second position by a user automatically causes a displacement of the respective sampling head 27 from the inactive position towards the sampling position and therefore a puncture of the puncturable closure membrane 7 of said container 2 by the respective sampling and venting needles 28, 29.

Advantageously, each sampling head 27 includes a positioning portion 31 configured to cover, and more particularly to cover, the cap 15 of a container 2 received in the respective receiving location 24 and to cooperate with said cap 15, so as to position said cap 15 in a predetermined position with respect to the respective sampling needle 28 and to the respective venting needle 29. Each positioning portion 31 is more particularly configured to align the respective sampling needle 28 with the tubular mounting portion 10 of the container 2 received in the respective receiving location 24 when the respective sampling head 27 occupies the sampling position.

According to the embodiment represented in FIGS. 4 to 8, each positioning portion 31 includes a bottom 32 and a side wall 33 which delimit a receiving housing 34 which is open downwards. The sampling needle 28 and the venting needle 29 of each sampling head 27 extend through the bottom 32 of the respective positioning portion 31 and protrude into the respective receiving housing 34.

Advantageously, the side wall 33 of each positioning portion 31 is configured to cooperate with the lateral skirt 17 of the cap 15 of the container 2 received in the respective receiving portion 23 when the respective sampling head 27 occupies the sampling position, and each receiving housing 33 is configured to at least partially house the cap of the container received in the respective receiving location when the respective sampling head occupies the sampling position.

More particularly, each positioning portion 31 includes an insertion opening 35 through which the cap 15 of the respective container 2 could be inserted into the respective receiving housing 34. Advantageously, each insertion opening 35 is internally delimited at least partially by a frustoconical surface which converges towards the bottom 32 of the respective positioning portion 31. Such a configuration of each positioning portion 31 allows ensuring centering of the cap 15 of the respective container 2 with respect to the respective sampling and venting needles 28, 29.

Each sampling head 27 also includes a biasing device 36 configured to bias the cap 15 of the respective container 2 outside the respective receiving housing 34, when said sampling head 27 is displaced towards the inactive position. Advantageously, each biasing device 36 is disposed in the receiving housing 34 of the respective cover portion 31.

According to the embodiment represented in FIGS. 4 to 8, each biasing device 36 includes a bearing member 37 which is slidably mounted in the respective receiving housing 34 between a protection position in which the respective sampling and venting needles 28, 29 are located set back from the bearing member 37 and a retracted position in which the respective sampling and venting needles 28, 29 protrude from the bearing member 27, and a biasing element 38, such as a coil spring, configured to bias the bearing member 37 towards the protection position. Advantageously, each bearing member 37 is configured to bear against the cap 15 of the container 2 received in the respective receiving portion 23 when said receiving portion 23 is displaced from the first position towards the second position, and each bearing member 37 is configured to be displaced from the protection position towards the retracted position by said cap 15 when the respective receiving portion 23 is displaced from the first position towards the second position.

The fact that each sampling head 27 is equipped with such a biasing device 36 allows avoiding any risk of a user coming into contact with the sampling and venting needles 27, 28 of the different sampling heads 27, and therefore any risk of injury of the user.

According to the embodiment represented in FIGS. 4 to 8, each bearing member 37 is located in the proximity of the respective insertion opening 35 when the bearing member 37 occupies the protection position, and is located at a distance from the respective insertion opening 35 when the bearing member 37 occupies the retracted position. Advantageously, each positioning portion 31 includes an abutment surface 39 against which the respective bearing member 37 abuts when said bearing member 37 is in the protection position.

The sampling device 21 further includes a plurality of air filters 41 each associated with a respective sampling head 27. Each air filter 41 is located upstream of the venting needle 29 of the respective sampling head 27 and is configured to filter air intended to flow through the respective venting needle 29 so as to avoid a contamination of the content of the respective container 2 during sampling of part of its content using the respective sampling needle 28. Advantageously, each air filter 41 is fluidly connected to the respective venting needle 29 by an air flow conduit 42.

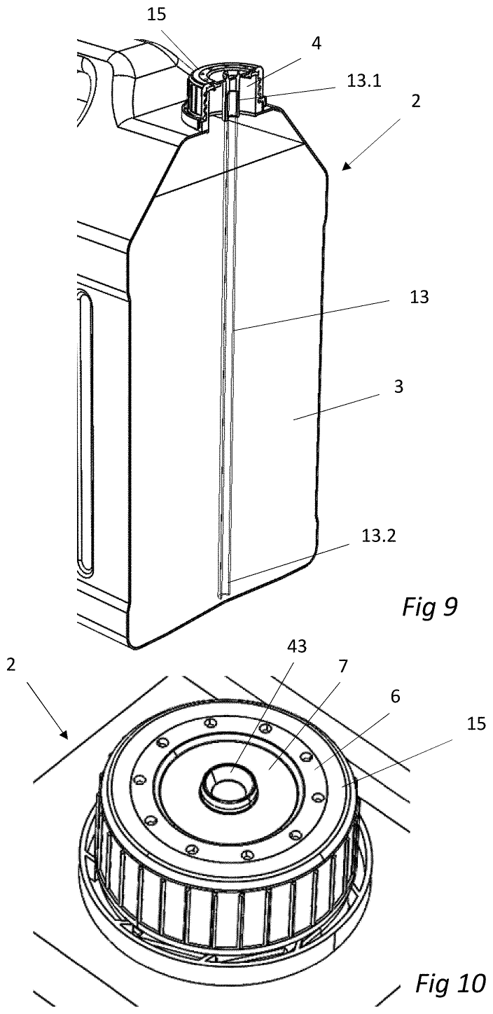

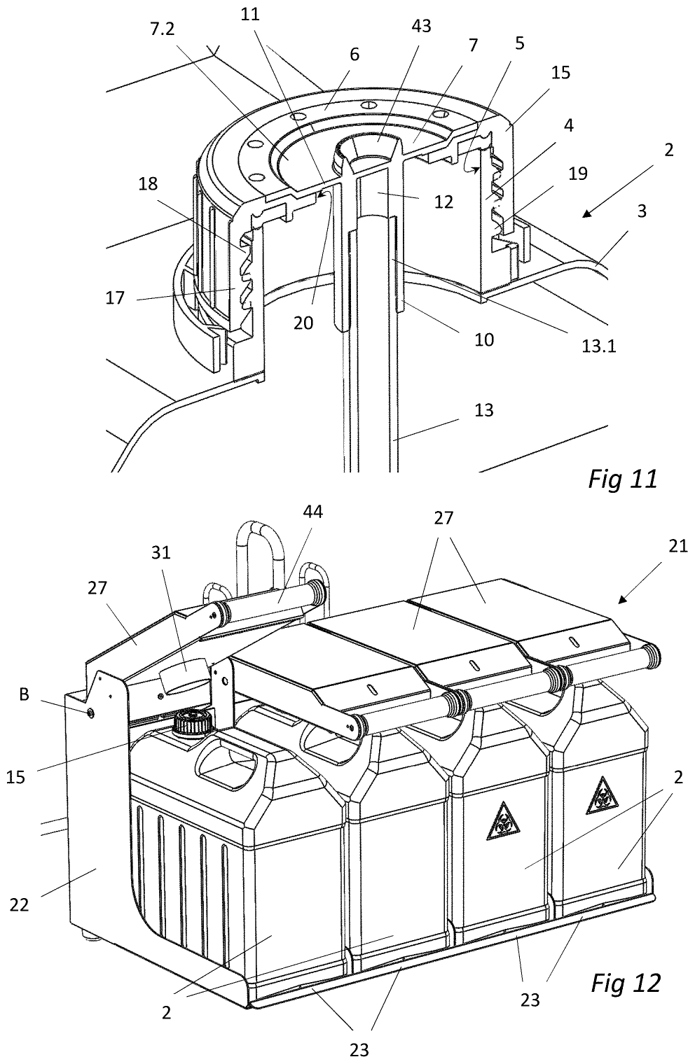

FIGS. 9 to 11 represent a container 2 for a reactive product according to a second embodiment of the invention which differs from the first embodiment represented in FIGS. 1 to 3 essentially in that the cap 15 and the closure member 6 are made by overmolding and in that the central portion of the puncturable closure membrane 7 is located upstream of the passage opening 20 with respect to the direction of insertion of a sampling needle through the puncturable closure membrane 7.

Furthermore, according to this second embodiment of the container 2, the cap 15 is removably attached to the neck 4 of the container body 3, and the first fastening element 18 includes an internal thread provided on the inner surface of the lateral skirt 17, and the second fastening element 19 includes an external thread which is provided on the outer surface of the neck 4 of the container body 3 and which is configured to cooperate by screwing with the internal thread provided on the lateral skirt 17.

In addition, according to this second embodiment of the container 2, the puncturable closure membrane 7 tightly covers the passage opening 20, and the closure member 6 includes an annular sealing rib 43 extending over the second face 7.2 of the puncturable closure membrane 7. Advantageously, the annular sealing rib 43 and the tubular mounting portion 10 extend substantially coaxially.

The container 2 represented in FIGS. 9 to 11 is a canister for a reactive product and has a capacity greater than 2 L, and may for example have a capacity of about 9 L. In particular, such a container 2 could be used to contain a reactive product whose required amount per test is about 20 ml. For example, such a container 2 may contain a dilution solution or a washing solution.

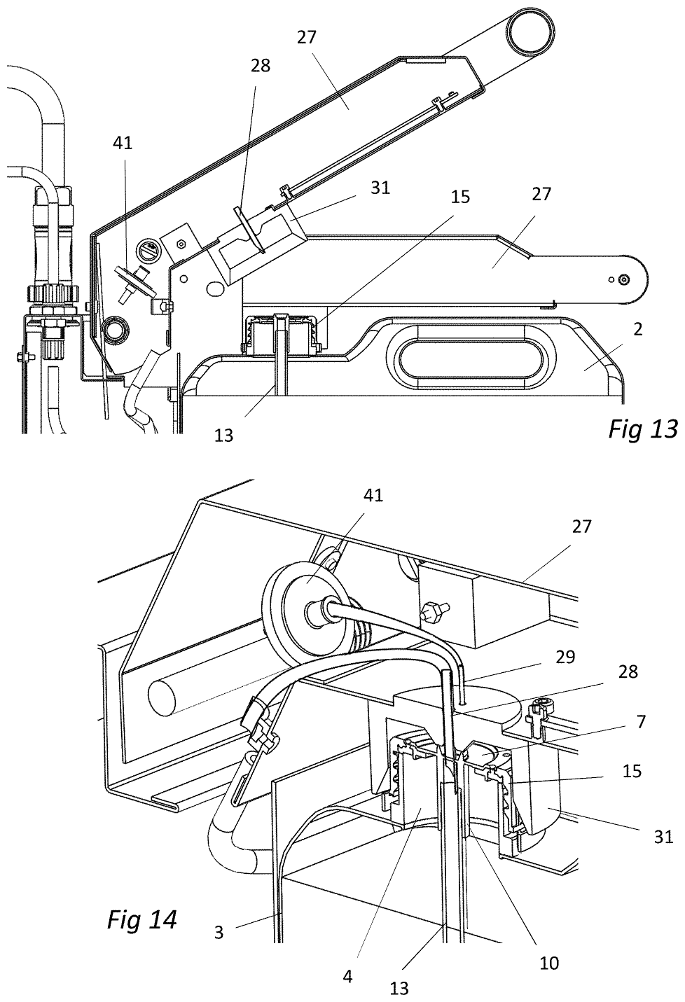

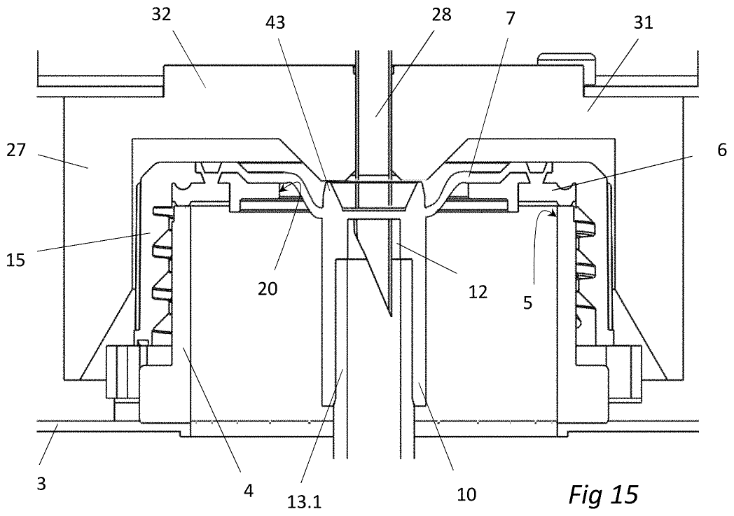

FIGS. 12 to 15 represent a sampling device 21 according to a second embodiment of the invention which is configured to receive a plurality of containers 2 according to the embodiment represented in FIGS. 9 to 11, and which differs from the sampling device 21 represented in FIGS. 4 to 8 essentially in that each receiving portion 23 is fixed relative to the frame 22, and in that each positioning portion 31 of each sampling head 27 is configured to exert a pressure on the annular sealing rib 43 of the closure member of the container 2 received in the respective receiving portion 23, when the respective sampling head 27 occupies the sampling position.

Advantageously, each sampling head 27 of the second embodiment of the sampling device 21 includes a gripping handle 44 so as to enables a manual displacement of said sampling head 27 between the inactive position and the sampling position, and each air filter 41 is housed in the respective sampling head 27.

According to a variant of the invention, one or more of the containers 2 received in the sampling device 21 represented in FIGS. 12 to 15 are used containers 2, that is to say which have been previously emptied of their content, and are intended to contain used washing solutions or any other liquid wastes. Because of the presence of the puncturable closure membrane on each container according to the present invention, such a container can be safely converted into a transportable waste container. Indeed, although the puncturable closure membrane of such a container has been previously punctured by a sampling needle and a venting needle, the intrinsic properties of the puncturable closure membrane enable it to “close” in a sufficiently tight manner, especially if the puncturable closure membrane is made of a so-called self-healing elastomer. According to the embodiment represented in FIGS. 12 to 15, two of the containers 2 contain reagents and two of the containers 2 are used containers.

It goes without saying that the invention is not limited only to the embodiments of this container 2 and of this sampling device 21, described hereinabove as examples, on the contrary, it encompasses all variants thereof.

1. A container for a reactive product, comprising:
a container body comprising a neck delimiting a neck opening;
a closure member comprising a puncturable closure membrane which tightly seals off the neck opening;
a suction tube located in the container body and comprising a first end portion attached to the closure member and a second end portion extending in proximity to a bottom of the container body; and
a cap attached to the neck of the container body, the cap comprising a passage opening which is located facing the puncturable closure membrane and the first end portion of the suction tube, the cap being configured so as to enable the penetration of a sampling needle and the puncturable closure membrane such that the sampling needle is fluidly connected to the suction tube, and so as to enable the penetration of a venting needle through the passage opening and the puncturable closure membrane such that the venting needle is fluidly connected to an internal volume of the container body.

2. The container according to claim 1, wherein the cap is configured to enable the penetration of the sampling needle through the passage opening and the puncturable closure membrane such that the sampling needle emerges opposite or into the first end portion of the suction tube, and so as to enable the penetration of the venting needle through the passage opening and the puncturable closure membrane such that the venting needle emerges into the internal volume of the container body.

3. The container according to claim 1, wherein the passage opening is located facing a central portion of the puncturable closure membrane.

4. The container according to claim 1, wherein the closure member comprises a tubular mounting portion which is located in the container body and which extends from the puncturable closure membrane the first end portion of the suction tube being attached to the tubular mounting portion and being fluidly connected to an internal channel delimited by the tubular mounting portion.

5. The container according to claim 4, wherein the passage opening is located facing a central portion of the puncturable closure membrane and the tubular mounting portion extends from the central portion of the puncturable closure membrane.

6. The container according to claim 4, wherein the tubular mounting portion extends according to an extension axis which is parallel to a central axis of the neck of the container body.

7. The container according to claim 1, wherein the puncturable closure membrane seals off the passage opening.

8. The container according to claim 1, wherein the cap is configured to exert a pressure on the puncturable closure membrane, so as to achieve a tight mounting of the puncturable closure membrane on the neck of the container body.

9. The container according to claim 1, wherein the cap includes a bottom wall and a lateral skirt extending from the bottom wall, the passage opening being provided on the bottom wall.

10. A sampling device, including:
a frame;
a receiving portion including a receiving location configured to receive a container according to any one of the preceding claims; and
a sampling head configured to sample at least part of a content of the container when the container is received in the receiving location, the sampling head being movably mounted relative to the frame between an inactive position and a sampling position, the sampling head including a sampling needle which is configured to puncture the puncturable closure membrane of the container and to be fluidly connected to the suction tube of the container when the container is received in the receiving location and when the sampling head is moved into the sampling position, and a venting needle which is configured to puncture the puncturable closure membrane of the container and to be fluidly connected to the internal volume of the container when the container is received in the receiving location and when the sampling head is moved into the sampling position.

11. The sampling device according to claim 10, wherein the sampling head is pivotably mounted relative to the frame about a pivot axis.

12. The sampling device according to claim 10, wherein the receiving portion is movably mounted relative to the frame between a first position in which a container can be inserted into the receiving location of said receiving portion, and a second position in which the sampling needle and the venting needle are able to extend through the puncturable closure membrane of said container.

13. The sampling device according to claim 12, wherein the sampling head is mechanically connected to the receiving portion such that a displacement of the receiving portion from the first position towards the second position automatically causes a displacement of the sampling head from the inactive position towards the sampling position, and such that a displacement of the receiving portion from the second position towards the first position automatically causes a displacement of the sampling head from the sampling position towards the inactive position.

14. The sampling device according to claim 13, wherein the receiving portion is slidably mounted on the sampling head in a direction of displacement.

15. The sampling device according to claim 10, wherein the sampling head includes a positioning portion configured to cooperate with the cap of a container received in the receiving location, so as to position the cap of the container in a predetermined position with respect to the sampling needle.

16. The sampling device according to claim 15, wherein the positioning portion includes a receiving housing which is open downwards and which is configured to at least partially house the cap of a container received in the receiving location.

17. The sampling device according to claim 10, which includes an air filter which is located upstream of the venting needle and which is configured to filter air intended to flow through the venting needle.

18. The container according to claim 2, wherein the passage opening is located facing a central portion of the puncturable closure membrane.

19. The container according to claim 18, wherein the closure member comprises a tubular mounting portion which is located in the container body and which extends from the puncturable closure membrane, the first end portion of the suction tube being attached to the tubular mounting portion and being fluidly connected to an internal channel delimited by the tubular mounting portion.

20. The container according to claim 19, wherein the passage opening is located facing a central portion of the puncturable closure membrane and the tubular mounting portion extends from the central portion of the puncturable closure membrane.
